(19) United States
(12) Patent Application Publication
(10) Pub. No.: US 2012/0121992 A1
(43) Pub. Date: May 17, 2012

(54) METAL-AIR CELL WITH HYDROPHOBIC AND HYGROSCOPIC IONICALLY CONDUCTIVE MEDIUMS

(75) Inventors: Cody A. FRIESEN, Fort McDowell, AZ (US); Ramkumar Krishnan, Gilbert, AZ (US)

(73) Assignee: Fluidic, Inc., Scottsdale, AZ (US)

(21) Appl. No.: 13/229,444

(22) Filed: Sep. 9, 2011

Related U.S. Application Data
(60) Provisional application No. 61/412,633, filed on Nov. 11, 2010.

(51) Int. Cl. H01M 8/22

(52) U.S. Cl. 429/403

(57) ABSTRACT

A rechargeable cell includes an air electrode for absorbing and reducing oxygen to a reduced oxygen species during discharge and oxidizing the reduced oxygen species during recharge to evolve oxygen. An outer surface of the air electrode is permeable to oxygen and water. A fuel electrode of the cell includes a metal fuel that it oxidizes during discharge and reduces during recharge. First and second ionically conductive layers of the cell have an interface therebetween. The first layer is between an inner surface of the air electrode and the interface. The second layer is an ionic liquid between an inner surface of the fuel electrode and the interface. The first layer is hygroscopic and the ionic liquid is hydrophobic so water absorbed through the air electrode is essentially prevented from diffusing across the interface into the ionic liquid.

The present application claims priority to U.S. Provisional Application Ser. No. 61/412,633, filed Nov. 11, 2010, the entirety of which is incorporated herein by reference.

This invention was made with U.S. government support under Contract No. DE-AR-00000038 awarded by the Depth inent of Energy. The government has certain rights in the invention.

### FIELD OF THE INVENTION

The present invention relates to a rechargeable electrochemical metal-air cell using a hydrophobic and a hygroscopic ionically conductive mediums interfacing one another.

### BACKGROUND

Metal-air cells are well known, and include a metal fuel electrode and an air electrode. During discharge, the metal fuel is oxidized at the metal fuel electrode and oxygen is reduced at the air electrode. In metal-air cells of the rechargaeable (a/k/a secondary) type, the metal fuel may be reduced on the fuel electrode, and oxygen may be evolved by oxidation at the air electrode or a separate charging electrode.

One of the most persistent challenges of these rechargeable metal-air cells is the presence of water. In aqueous electrolyte systems, water is present in a bulk amount to dissolve the electrolyte salt. Even in systems without the purposeful inclusion of significant amounts of water, such as non-aqueous systems or the ionic liquid based cell system disclosed in U.S. application Ser. Nos. 12/776,962, 61/177,072 and 61/267,240 (each incorporated herein by reference), water uptake can still occur because of the natural presence of water vapor in the air that can permeate the air electrode. Water in the cell system can have some benefit, particularly during recharge as it can be oxidized to evolve oxygen. Also, under alkaline/basic conditions water content can provide hydroxide ions for supporting or bonding/coordinating with the oxidized fuel cations during discharge. And any water consumed or lost from the cell may be replenished by further water vapor uptake through the air electrode from the ambient atmosphere. However, the presence of water typically presents significant challenges at the fuel electrode. At the fuel electrode, the presence of water in contact with the metal fuel leads to self-corrosion of the metal fuel, as the metal oxidation and hydrogen reduction reactions may occur simultaneously at the fuel electrode. This can occur even when the cell is not in use, as it occurs internally within the cell and locally at the fuel electrode irrespective of whether the electrodes are connected to an external load circuit.

### SUMMARY OF THE INVENTION

One aspect of the present invention provides an air electrode for absorbing and reducing oxygen to a reduced oxygen species during a discharge cycle and oxidizing the reduced oxygen species during a recharge cycle to evolve oxygen, the air electrode having an outer surface permeable to oxygen and water; a fuel electrode comprising a metal fuel for oxidizing the fuel during the discharge cycle and reducing the fuel during the recharge cycle; a first ionically conductive layer and a second ionically conductive layer with an interface therebetween; the first ionically conductive layer being provided between an inner surface of the air electrode and the interface; the second ionically conductive layer being an ionic liquid provided between an inner surface of the fuel electrode and the interface, the ionic liquid being a low temperature ionic liquid having a melting point below 150° C. at 1 atm.; the first ionically conductive layer being hygroscopic and the ionic liquid being hydrophobic such that the first ionically conductive layer absorbs water through the air electrode but the water is essentially prevented from diffusing across the interface into the ionic liquid; the first ionically conductive layer and the ionic liquid both being conductive for the reduced oxygen species and permitting transport of the reduced oxygen species across the interface therebetween for reaction with the oxidized metal fuel during the discharge cycle and for oxidation to oxygen during the recharge cycle.

Other objects, features, and advantages of the present invention will become apparent from the following detailed description, the accompanying drawings, and the appended claims.

### BRIEF DESCRIPTION OF THE DRAWINGS

FIG. 1 is a cross-sectional view (not to scale) of a cell in accordance with an embodiment of the invention.

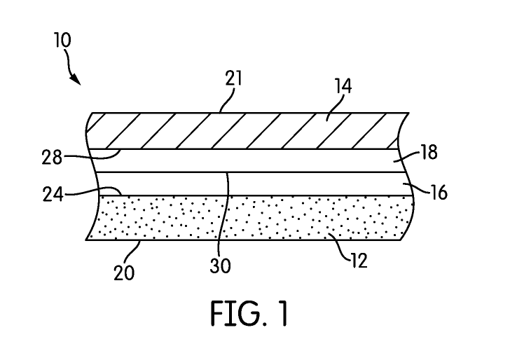

### DETAILED DESCRIPTION OF THE ILLUSTRATED EMBODIMENT(S)

The principles of any embodiment of the invention may be applied to any of the cells taught in Ser. Nos. 12/776,962, 12/385,217, 12/385,489, 12/631,484, 12/549,617, 61/177,072, 12/885,268, 13/019,923, 12/901,410, 13/083,929, 13/028,496, 13/167,930, 61/383,510, 61/394,954 61/439,759, 61/365,645, 61/515,749 and 61/267,240, each of which is incorporated herein by reference. The examples disclosed and described herein are not intended to be limiting.

A rechargeable electrochemical metal-air cell, shown at 10 in the Figures, comprises an air electrode 12, a fuel electrode 14, a semi-solid ionically conductive layer 16, and an ionic liquid 18. The cell 10 may have any construction or configuration, and may include a housing (not shown) for containing all the components. The cell 10 may be wound in a roll or arranged in another non-linear configuration, as disclosed in the above-incorporated , '962, '072 and '240 applications, with the electrodes 12, 14 and layer 16 being flexible (and the ionic liquid is liquid and thus conforms to the volume dictated by its surrounding surfaces). As mentioned in those applications, the separator may be permeable to air so that air can flow to the outer surface of the air electrode 12. A flexible, non-conductive (i.e., insulative) separator may be positioned between the outer surfaces 20, 21 of the electrodes 12, 14, respectively to maintain separation between them.

The air electrode 12 is configured to absorb and reduce oxygen to a reduced oxygen species, such as hydroxide ions, during a discharge cycle and oxidize the reduced oxygen species during a recharge cycle to evolve oxygen. The air electrode 12 has an outer surface permeable 20 to gaseous oxygen and water. The outer surface of the air electrode 12 faces ambient atmospheric air to absorb its oxygen and water content. Other oxidizer sources may be used, such as oxygen enriched air, pure oxygen, etc. As will be discussed below, the oxygen is reduced during discharge of the cell. Also, oxygen evolved during re-charge, as discussed below, as an option may escape the cell via surface 20.

The air electrode 12 may be made porous to provide gaseous oxygen diffusion from the air side of the electrode (i.e., outer surface 20) to reaction sites within the electrode 12 and to provide ionic conductivity for reactants and reaction products on the electrolyte side of the electrode 12. A current collector may be embedded in the electrode to provide high electrical conductivity. The materials of construction may include carbon particles; PTFE, FEP, PFA, or another fluorinated polymer; electrocatalysts that may be metal oxides such as manganese oxide, nickel oxide, cobalt oxide, or doped metal oxides; electrocatalysts that may be metals such as nickel, cobalt, manganese, silver, platinum, gold, palladium, or another electrocatalytically active material; or electrocatalysts in the form of spinels or perovskites. These examples are not limiting.

Further details regarding the air electrode may also be found in the above-incorporated applications.

The fuel electrode 14 comprises a metal fuel for oxidizing the fuel during the discharge cycle and reducing the fuel during the recharge cycle. For example, the metal fuel may comprise at least one selected from the group consisting of magnesium, lithium, calcium, sodium and aluminum. In some embodiments, the metal fuel may comprise aluminum (Al). As will discussed in further detail below, the present invention is advantageously used with these metals, as they are highly reactive in the presence of water and thus difficult to use in prior art cell designs. Indeed, any of the metals in Groups I-III and XIII-XIV of the periodic table (including the metalloids, such as boron and silicon, which are regarded as metals for purposes of this application) may advantageously be used despite their high reactivity with water. The cell described herein is uniquely designed to greatly reduce or eliminate the issues of water content at the fuel electrode while still retaining the advantages of water content at the air or charging electrode. The cell may also be used with metals that are less reactive with water, such as zinc, manganese and nickel, and others from Groups IV-XII of the periodic table.

The fuel electrode 14 may have any construction or configuration. For example, the fuel electrode may be a block body of the metal fuel. Or it may have one or more electroconductive screens, meshes, or bodies on which the metal fuel may be deposited or otherwise collected. Neither approach is intended to be limiting.

The fuel and air electrodes 12, 14 in the drawing(s) are shown as single pieces in cross-section for convenience, but this should not be regarded as limiting, and the electrodes 12, 14 may be multi-component and/or multi-layer constructions. Reference may be made to the above-incorporated patent applications for the basic principles of how the air and fuel electrodes 12, 14 are designed and function.

The semi-solid layer 16 and the ionic liquid 18 may be referred to as first and second ionically conductive layers for convenience. As will be discussed later below, in other embodiments a layer may take different form or have different characteristics. In some embodiments, a layer may include sub-layers. For example, the semi-solid layer 16 may have two sub-layers for imparting different characteristics (i.e., a sub-layer contacting the air electrode may include an additive for promoting the oxidation/reduction reactions of the air electrode, while a sub-layer contacting the interface 30 may be designed for promoting transport of oxygen species), but the presence of multiple sub-layers still may be regarded as a collective layer.

The semi-solid ionically conductive layer 16 is provided on an inner surface 24 of the air electrode 12. Additionally, an ionic liquid 18 is provided between an inner surface 28 of the fuel electrode 14 and the semi-solid ionically conductive layer 16. Thus, an interface 30 is defined between the ionic liquid 18 and the semi-solid ionically conductive layer 16. The ionic liquid 18 is a low temperature ionic liquid, and preferably a room temperature liquid.

For the purposes of this application, a low temperature ionic liquid is defined as an ionic liquid having a melting point at or below 150° C. at 1 atm. These low temperature ionic liquids may also include the species known as room temperature ionic liquids, which are defined as ionic liquids having a melting point at or below 100° C. at 1 atm. Ionic liquids are also referred to as liquid salts. By definition, an ionic liquid is composed primarily of anions and cations of the salt. While an ionic liquid itself may be a solvent with respect to one or more other soluble products present in the ionic liquid, such as an additive or reactant by-product created by operation of the cell, an ionic liquid does not require the use of a solvent to dissolve the salt, as the liquid itself is “self-dissolving,” i.e., it is a liquid of the electrolyte salt anions and cations by its own nature, and the use of a separate solvent to dissolve the salt is not necessary.

However, even though low temperature or room temperature ionic liquids are defined by their respective melting points at 1 atm., in some embodiments the cell may be operated in an environment with a different pressure, and thus the melting point may vary with the operating pressure. Thus reference to a melting point at 1 atm. is used as a reference point to define these liquids, and does not imply or restrict its actual use conditions in operation.

In some non-limiting embodiments, a substance that may be regarded in some contexts as a solvent may be added in relatively small amounts to the ionic liquid 18, either for enhancing the solubility of solutes in the ionic liquid 18, such as an additive added to or a by-product created in the ionic liquid by operation of the cell, or for providing a non-solvent functionality, such as the promotion of certain electrochemical reactions or transport of ions. Thus, the use of an ionic liquid 18 does not entirely exclude the presence of a substance that may be regarded as solvent in other contexts, or act as a solvent with respect to solutes in the ionic liquid 18, but because a solvent is not necessary to dissolve an ionic liquid 18, it can be used in a substantially smaller amount compared to conventional electrolyte salts requiring a bulk solvent for dissolution of the salt per se, such as aqueous electrolyte solutions. Indeed, in some non-limiting embodiments it is possible that no additive solvent is used.

In some non-limiting embodiments, the medium between the fuel electrode 14 and the semi-solid layer 16 may be a pure low temperature ionic liquid, i.e., it consists of the ionic liquid. In other non-limiting embodiments, it may consist essentially of the ionic liquid, meaning for the purposes of this application that it may include the ionic liquid and one or more other substances that do not materially effect its characteristic of being an ionic liquid. Thus, the term “consisting essentially of an ionic liquid expressly encompasses the addition of one or more additives to enhance the ionic transport functionality of the ionic liquid, support the electrochemical reactions of the cell and/or enhance the solubility of solutes in the ionic liquid, but excludes the use of a bulk solvent required to dissolve the salt, such as is the case with aqueous electrolyte solutions. Of course, any presence of reaction by-products or ions in the ionic liquid would be permitted in either the embodiments consisting of the ionic liquid or the embodiments consisting essentially of the ionic liquid, as the very nature of the ionic liquid is to promote the transport and/or formation of such ions and/or by-products. The terms “solvent free” or “devoid of solvent” may be used to characterize the ionic liquid, and this terminology should be understood as (a) only excluding a bulk solvent that is provided for purposes of dissolving the ionic liquid, and not excluding the ionic liquid itself, which may act as a solvent with respect to another substance (e.g., an additive or the cell reaction by-products); and (b) not excluding the presence of one or more additives to enhance the ionic transport functionality of the ionic liquid, support the electrochemical reactions of the cell and/or enhance the solubility of solutes in the ionic liquid, even if such an additive theoretically could be regarded as a solvent in other contexts or with respect to solutes in the ionic liquid, but is not functioning for purposes of dissolution of the ionic liquid.

In some embodiments, the ionic liquid 18 may have a vapor pressure equal to or less than 1 mm Hg at 20° C. above the ionic liquid's melting point at 1 atm. More preferably, it has a vapor pressure equal to or less than 0.5 mm Hg or 0.1 mm Hg at 20° C. above the ionic liquid's melting point at 1 atm. Still more preferably, the ionic liquid has a vapor pressure that is essentially immeasurable at 20° C. above the ionic liquid's melting point at 1 atm., and thus is regarded as essentially zero. Because a low or immeasurable vapor pressure means little or no evaporation, an excessive amount of ionic liquid 18 need not be included in the cell or in a separate reservoir to compensate for excessive evaporation over time. Thus, in some embodiments a relatively low amount of ionic liquid 18—even just a minimal amount sufficient to support the electrochemical reactions—can be used in the cell, thus reducing its overall weight and volume and increasing its power to volume/weight ratios. Moreover, this ability to have a lower volume enables the cell to have a thinner profile, which enables it to be wound into or otherwise arranged in a compact configuration.

The ionic liquid's melting point plus 20° C. at 1 atm. is used as the reference point for the ionic liquid's vapor pressure as a matter of convenience. Generally, a cell's operating temperature is above the ionic liquid's melting point, but the actual operating temperature may be different or may fluctuate in some embodiments. Rather than choose a point of reference that may vary based on operating conditions, such as the operating temperature, the ionic liquid's melting point plus 20° C. at 1 atm. may be used as a stable and verifiable reference point. The fact that this is used as a reference point does not imply that the cell need necessarily be operated at that temperature, and the operating temperature may be any temperature at or above the ionic liquid's melting point.

The vapor pressure of the ionic liquid 18 at the operating temperature (which may be within a range of operating temperatures) may also be used as the reference point as well. Thus, in some embodiments the cell operation method may be performed with the ionic liquid 18 at a temperature at or above its melting point and at which the vapor pressure of the ionic liquid 18 is less than or equal to the specified value. For example, the vapor pressure at the operating temperature may be at or below 1 mm Hg, 0.5 mm Hg, 0.1 mm Hg or immeasurable and essentially zero. Optionally, a heater, such as a controlled heater with temperature feedback, may be used to heat the cell and its ionic liquid to the operating temperature and maintain the temperature at a target temperature or within a target range. In some embodiments, no heater is necessary, and the cell may be designed to operate at standard ambient conditions (or it may operate in a high temperature environment where a heater is unnecessary).

The ionic liquid 18 may be any suitable ionic liquid. For example, the ionic liquid may be formed of butylmethyl-pyrrolidinium as cations and bis(trifluoromethanesulfonyl)imide (bisTFSI) as anions. Other cation examples include other alkyl-pyrrolidinium derivatives, alkyl-morpolonium, alkyl-imidazolium, alkyl-pyridinium, or choline; other anion examples include nonaflate (C₄F₉0₃S), bis(pentafluoroethyl sulfonyl)imide, tetrafluoroborate, and hexafluorophosphate, as non-limiting examples. Reference may be made to the above incorporated applications, including the, '962, '072 and '240 applications, for further discussions of ionic liquids, examples, and their properties.

See also U.S. Provisional Appln. Ser. No. 61/498,308, the entirety of which is incorporated herein by reference, which describes ionic liquids comprising an anion having the formula R—SO₃⁻, wherein R is a substituted or unsubstituted alkyl group having C₂-C₂₀ carbon atoms, which together may form a ring, together with a suitable cation. Suitable sulfonates in that application include, for example, isethionate, taurinate, 3-morpholinopropanesulfonate (MOPS), Goods buffers or reagents, and the like. Any cation may be used so long as it forms an electrically conductive ionic liquid with the sulfonate anion. Suitable cations are those containing tertiary nitrogens that have been quaternized and subsequently converted into the corresponding positive ion. Some representative cations include, but are not limited to pyrrolidines, piperidines, imidazoles, pyridines, morpholines, and the like. Particularly preferred cations are alkyl-1,4-diazabicyclo[2.2.2]octanium (alkyl-DABCO), 1-ethyl-2,3-dimethylimidazolium, N-ethyl-N-methylmorpholinium, 1-methylimimdazo[1,2-a]pyridinium, tetramethylammonium, and the like.

Preferably, but optionally, the ionic liquid 18 is aprotic. Because the ionic liquid 18 is in direct contact with the metal fuel, having it be aprotic may prevent it from self-corroding the metal fuel. That is, an aprotic ionic liquid has no or essentially no protons available to be reduced in the local presence of fuel oxidation at the fuel electrode 14, and this functions to further limit self-corrosion of the metal fuel. An aprotic ionic liquid has no acidic protons or the protons within the aprotic liquid structure have a pKa above 16.5.

The ionically conductive layer 16 is preferably a gel. The layer 16 may be formed of combinations of gelled aqueous potassium hydroxide, paste aqueous potassium hydroxide, or gels of other alkali hydroxides, alkali polyacrylates, or cross-linked polyacrylamide, as non-limiting examples. One or more additives may be included in the layer 16 for increasing its hygroscopicity, including but not limited to LiCl, ZnCl₂, K(CO₃) or K (PO₄) as examples. Having the layer 16 formed as a gel or other suitable semi-solid (e.g., a paste) is preferred because it prevents the layer 16 from mixing substantially with the ionic liquid 18, thus enabling them to be maintained as separate and distinct phases. However, because they are in contact along interface 30, ion transport may occur therebetween, as will be discussed below.

Preferably, the gel or other semi-solid material of the layer 16 can permeate or fill into the pores at surface 24 of the air electrode 12. Advantageously, the semi-solid material of layer 16 may penetrate into the body of the air electrode 12. This provides intimate contact between the air electrode 12 and layer 16 to promote ion conductivity.

In some embodiments, a gel may be applied in a flowing/liquid uncured state to the electrode surface 24, and then cured in place to create the gel as layer 16 on the electrode 14, such as by heat or radiation. This may advantageously create high amounts of intimate contact, because the uncured material can penetrate deeply into the electrode body prior to curing.

A separator (not shown) may be used between the semi-solid layer 16 and the fuel electrode 14 to prevent contact therebetween, for the reasons discussed below. The separator should be chemically inert in the system and insulating (i.e., not conductive). For example, ribs, an open celled lattice, or any other structure that maintains separation between the fuel electrode 14 and semi-solid layer 16 may be used.

The ionically conductive layer 16 and the ionic liquid 18 may each be basic (i.e., hydroxide supporting, or in the case of an aqueous solution, alkaline), and thus contain hydroxide ions mobile therein in excess of equilibrium. Hydroxide ions may be conducted between the layers across interface 30 to support the reactions, as discussed below.

The semi-solid ionically conductive layer 16 is hygroscopic and the ionic liquid 18 is hydrophobic such that the ionically conductive layer 16 absorbs water through the air electrode 12, but the water has a preference for remaining in the hygroscopic layer 16 is essentially or entirely prevented from diffusing across the interface 30 into the ionic liquid 18. That is, because the ionically conductive layer 16 is hygroscopic, it absorbs water. But because the ionic liquid 16 is hydrophobic, it repels water—a function that is enhanced by being in contact with the hygroscopic layer which readily accepts the water. Thus, because they contact one another along interface 30, any water in the system will have a strong preference for remaining in the hygroscopic semi-solid layer 16. Thus, the water may be essentially or entirely prevented from diffusing across the interface. The term “essentially” is used to recognize that 100% perfection is not required, but that the amount of water that may cross the interface is de minimis in the operational context of the cell. The hydrophobic and hygroscopic characteristics of the layer 16 and ionic liquid 18 may defined be relative to one another, rather than against external quantitative parameters, for this reason. Alternatively, they may be characterized as hydrophobic/hygroscopic against known parameters.

For example, the hydrophobicity of the ionic liquid may be set such that the corrosion rate (i.e., undesirable self-corrosion when the cell is inactive) of the metal fuel corresponds to a current of less than 15 μa/cm², and preferably less than 10 μa/cm². That is, the hydrophobicity maintains water content at a low enough level that the self-corrosion due to interaction with the water (and particularly the hydrogen ions thereof) results in a local current below the relevant value. This local current is not to be confused with the external current generated during discharge of the cell, but rather refers to the local rate of electron transport due to the self-corrosion reaction.

Similarly, the hygroscopicity of the semi-solid layer retains water content in that layer at at least a level sufficient to support the reactions occurring therein, as described below. Preferably, the water content is sufficiently high so that the half-cell reactions involving the water content during charge/discharge are not limiting on the overall cell reaction (i.e., the water content is not so low that its unavailability limits the reaction).

These quantitative values are not intended to be limiting.

The semi-solid ionically conductive layer 16 and the ionic liquid 18 are both hydroxide ion conductive and permit hydroxide ion transport across the interface 30 therebetween to provide hydroxide ions for reaction with or supporting the oxidized metal fuel in the ionic liquid 18 during the discharge cycle and to provide hydroxide ions for oxidation to oxygen during the recharge cycle. In embodiments where the reduced oxygen species is in another form, they may be conductive for transport of that species.

Specifically, during discharge, the air and fuel electrodes 12, 14 are coupled to a load. Using aluminum as the example, the oxidation and reduction reactions during discharge are as follows:

2Al→2Al³⁺+6e⁻ (oxidation half-cell reaction) (1)

3/2O₂+6e⁻+3H₂O→6(OH)⁻ (reduction half-cell reaction) (2)

The byproducts may react in the ionic liquid 18 to form aluminum hydroxide as follow:

2Al³⁺+6(OH)⁻→2Al(OH)₃ (byproduct reaction) (3)

Thus, the mobility of the hydroxide ions from the semi-solid layer 16 to the ionic liquid 18 enables the hydroxide ions to be present in the ionic liquid 18, supporting and/or reacting with the oxidized fuel. Also, the presence of water in the semi-solid layer supports the reduction of oxygen to hydroxide ions. However, water is essentially prevented or prevented from migrating to the fuel electrode 14, thus precluding availability of the same for fuel electrode corrosion and hydrogen evolution. This is prevented not only because of the hydrophobic characteristic of the ionic liquid 18 functioning to repel the water, but also because of the hygroscopic nature of the ionically conductive semi-solid layer 16 that attracts water.

In contrast, if water is permitted to contact the fuel electrode 14, a reactive metal like aluminum will readily self-corrode, basically oxidizing the metal and evolving hydrogen locally at the fuel electrode 14. With aluminum as the example, this will form Al(OH)₃ or Al₂O₃.3(H₂O). This is self-consuming. Also, the metal oxidation may form a passivation layer that could effectively shut down the cell by encapsulating/shielding the available metal from the ionic liquid 18.

Additionally, the presence of water in the hygroscopic semi-solid layer 16 supports the recharge cycle. Specifically, the presence of hydroxide ions in the semi-solid layer 16 by water absorption and dissolution in the layer 16 supports the recharge cycles by providing a source of oxygen for evolution during recharge. Also, water formed during the oxygen evolution from the reaction of excess hydrogen and hydroxide ions is readily accepted in the semi-solid layer 16. Continuing to use aluminum as the example, the oxidation and reduction reactions during recharge are as follows:

2Al(OH)₃→2Al³⁺+6(OH)⁼ (byproduct reaction) (4)

2Al³⁺+6e⁻→2Al (metal reduction half-cell reaction) (5)

6(OH)⁻→6e⁻+3H₂O+3/2O₂ (oxygen oxidation/evolution reaction) (6)

Thus, the aluminum (or other metal) is reduced and electrodeposited on the fuel electrode 14, and oxygen is evolved, which may exit the cell 10 via the air electrode 12 or one or more ports. Al(OH)₃ may beneficially have a reasonably low overpotential for disassociation during recharge, thus facilitating its reversibility.

The cell 10 may have a terminal for each electrode (i.e., the air electrode 12, the fuel electrode 14, and if used the charging electrode). The terminals may be used to couple the relevant electrodes of the cell 10 to a load (during discharge) or a power source (during recharge). A number of the cells 10 may be coupled in series and/or parallel, with terminals for connections between the cells, optional switches for managing the connections, and primary terminals for coupling the system of cells 10 to a load or power source, as is applicable.

Thus, the cell 10 is designed to retain the benefits of water presence at the air electrode 12 (and, if used, a charging electrode), while reducing or eliminating the problems with water presence at the fuel electrode 14. As a result, the cell 10 may be particularly useful with metal fuels that are highly reactive with water, including aluminum (discussed above) as well as magnesium, calcium, sodium, and lithium. As used herein, the term metal fuel includes elemental metal, an alloy of the metal, a hydride of the metal, and/or molecule or complex of the metal. Thus, metal fuel is a broad term encompassing any variant of a metal.

The semi-solid material of first layer 16 may also be replaced with a liquid, and a membrane or other barrier may be used as the interface between layer 16 and ionic liquid 18 to prevent mixing (similarly, such a barrier could be used with the semi-solid material at the interface 30 as well). The liquid of layer 16 may have the same characteristics as the semi-solid, i.e., hygroscopicity relative to liquid 18, basic/hydroxide containing, hydroxide mobility, etc. Likewise, the permeability of the air electrode may be restricted further to prevent wicking of the liquid in layer 16. Materials as noted above may be included in the layer 16 for providing its functionality of supporting electrochemical reactions and water uptake, except that the binder/matrix components for creating the semi-solid state would be omitted. In such an embodiment, the barrier may be impermeable to the two liquids to prevent mixing and cross-dilution, but conductive for the reduced oxygen species to prevent its transport as discussed above.

The foregoing embodiments have been provided to illustrate the structural and functional principles of the present invention, and should not be regarded as limiting. To the contrary, the present invention(s) are intended to encompass all modifications, alterations, substitutions or equivalents within the spirit and scope of the following claims.

What is claimed:

1. A rechargeable electrochemical metal-air cell, comprising:
an air electrode for absorbing and reducing oxygen to a reduced oxygen species during a discharge cycle and oxidizing the reduced oxygen species during a recharge cycle to evolve oxygen, the air electrode having an outer surface permeable to oxygen and water;
a fuel electrode comprising a metal fuel for oxidizing the fuel during the discharge cycle and reducing the fuel during the recharge cycle;
a first ionically conductive layer and a second ionically conductive layer with an interface therebetween;
the first ionically conductive layer being provided between an inner surface of the air electrode and the interface;
the second ionically conductive layer being an ionic liquid provided between an inner surface of the fuel electrode and the interface, the ionic liquid being a low temperature ionic liquid having a melting point below 150° C. at 1 atm.;
the first ionically conductive layer being hygroscopic and the ionic liquid being hydrophobic such that the first ionically conductive layer absorbs water through the air electrode but the water is essentially prevented from diffusing across the interface into the ionic liquid;
the first ionically conductive layer and the ionic liquid both being conductive for the reduced oxygen species and permitting transport of the reduced oxygen species across the interface therebetween for reaction with the oxidized metal fuel during the discharge cycle and for oxidation to oxygen during the recharge cycle.

2. A cell according to claim 1, wherein the first ionically conductive layer is a semi-solid.

3. A cell according to claim 2, wherein the ionic liquid and the semi-solid ionically conductive layer are basic.

4. A cell according to claim 2, wherein the semi-solid ionically conductive layer is a gel.

5. A cell according to claim 2, wherein the metal fuel comprises at least one selected from the group consisting of magnesium, lithium, calcium, sodium and aluminum.

6. A cell according to claim 5, wherein the metal fuel comprises aluminum.

7. A cell according to claim 3, wherein the metal fuel comprises at least one selected from the group consisting of magnesium, lithium, calcium, sodium and aluminum.

8. A cell according to claim 7, wherein the metal fuel comprises aluminum.

9. A cell according to claim 3, wherein the semi-solid ionically conductive layer is a gel.

10. A cell according to claim 9, wherein the metal fuel comprises at least one selected from the group consisting of magnesium, lithium, calcium, sodium and aluminum.

11. A cell according to claim 10, wherein the metal fuel comprises aluminum.

12. A cell according to claim 2, wherein the ionic liquid is aprotic.

13. A cell according to claim 3, wherein the ionic liquid is aprotic.

14. A cell according to claim 4, wherein the ionic liquid is aprotic.

15. A cell according to claim 5, wherein the ionic liquid is aprotic.

16. A cell according to claim 6, wherein the ionic liquid is aprotic.

17. A cell according to claim 8, wherein the ionic liquid is aprotic.

18. A cell according to claim 9, wherein the ionic liquid is aprotic.

19. A rechargeable electrochemical cell according to claim 2, wherein said fuel electrode, air electrode and semi-solid ionically conductive layer are flexible to enable the cell to be arranged in a non-linear compacted configuration.

20. A rechargeable electrochemical cell according to claim 19, wherein the cell is wound in a roll as the non-linear compacted configuration.

21. A rechargeable electrochemical cell according to claim 2, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

22. A rechargeable electrochemical cell according to claim 3, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

23. A rechargeable electrochemical cell according to claim 4, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

24. A rechargeable electrochemical cell according to claim 5, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

25. A rechargeable electrochemical cell according to claim 12, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

26. A rechargeable electrochemical metal-air cell, comprising:
an air electrode for absorbing and reducing oxygen to a reduced oxygen species during a discharge cycle and oxidizing the reduced oxygen species during a recharge cycle to evolve oxygen, the air electrode having an outer surface permeable to oxygen and water;
a fuel electrode comprising a metal fuel for oxidizing the fuel during the discharge cycle and reducing the fuel during the recharge cycle;
a first ionically conductive layer and a second ionically conductive layer with an interface therebetween;
the first ionically conductive layer being provided between an inner surface of the air electrode and the interface;
the second ionically conductive layer being an ionic liquid provided between an inner surface of the fuel electrode and the interface, the ionic liquid being a low temperature ionic liquid having a melting point below 150° C. at 1 atm.;
the first ionically conductive layer being hygroscopic and the ionic liquid being hydrophobic such that the first ionically conductive layer absorbs water through the air electrode and the water has a preference for remaining in the first ionically conductive layer over diffusing across the interface into the ionic liquid;
the first ionically conductive layer and the ionic liquid both being conductive for the reduced oxygen species and permitting transport of the reduced oxygen species across the interface therebetween for reaction with the oxidized metal fuel during the discharge cycle and for oxidation to oxygen during the recharge cycle.

27. A cell according to claim 26, wherein the first ionically conductive layer is a semi-solid.

28. A cell according to claim 27, wherein the ionic liquid and the semi-solid ionically conductive layer are basic.

29. A cell according to claim 27, wherein the semi-solid ionically conductive layer is a gel.

30. A cell according to claim 27, wherein the metal fuel comprises at least one selected from the group consisting of magnesium, lithium, calcium, sodium and aluminum.

31. A cell according to claim 30, wherein the metal fuel comprises aluminum.

32. A cell according to claim 28, wherein the metal fuel comprises at least one selected from the group consisting of magnesium, lithium, calcium, sodium and aluminum.

33. A cell according to claim 32, wherein the metal fuel comprises aluminum.

34. A cell according to claim 28, wherein the semi-solid ionically conductive layer is a gel.

35. A cell according to claim 34, wherein the metal fuel comprises at least one selected from the group consisting of magnesium, lithium, calcium, sodium and aluminum.

36. A cell according to claim 35, wherein the metal fuel comprises aluminum.

37. A cell according to claim 27, wherein the ionic liquid is aprotic.

38. A cell according to claim 28, wherein the ionic liquid is aprotic.

39. A cell according to claim 29, wherein the ionic liquid is aprotic.

40. A cell according to claim 30, wherein the ionic liquid is aprotic.

41. A cell according to claim 31, wherein the ionic liquid is aprotic.

42. A cell according to claim 33, wherein the ionic liquid is aprotic.

43. A cell according to claim 34, wherein the ionic liquid is aprotic.

44. A rechargeable electrochemical cell according to claim 27, wherein said fuel electrode, air electrode and semi-solid ionically conductive layer are flexible to enable the cell to be arranged in a non-linear compacted configuration.

45. A rechargeable electrochemical cell according to claim 44, wherein the cell is wound in a roll as the non-linear compacted configuration.

46. A rechargeable electrochemical cell according to claim 27, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

47. A rechargeable electrochemical cell according to claim 28, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

48. A rechargeable electrochemical cell according to claim 29, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

49. A rechargeable electrochemical cell according to claim 30, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.

50. A rechargeable electrochemical cell according to claim 37, wherein the semi-solid ionically conductive medium is characterized such that the air electrode reduces oxygen to hydroxide ions as the reduced oxygen species, wherein the semi-solid ionically conductive layer and the ionic liquid are both conductive for the hydroxide ions and permit transport of the hydroxide ions across the interface therebetween.
